(19) United States
(12) Patent Application Publication
(10) Pub. No.: US 2002/0144460 A1
(43) Pub. Date: Oct. 10, 2002

(54) Removable planter for cemetery plots

(76) Inventors: Thomas M. Ebmeyer, Holbrook, NY (US); Christine Ebmeyer, Holbrook, NY (US)

Correspondence Address: Michael I. Kroll, 171 Stillwell Lane, Syosset, NY, 11791, US

(21) Appl. No.: 09/779,385

(22) Filed: Feb. 8, 2001

(51) Int. Cl. A01G 9/02

(52) U.S. Cl. 47/65.5

(57) ABSTRACT

The present invention 10 discloses a removable planter for use in cemetery plots 14 having tapered sides so that the planters can be nested one inside the other. A name plate 38 is also provided to be prominently displayed on the present invention 10 also having a horizontal flange 32 disposed about the upper periphery of the present invention. Drain holes 36 are also provided in the bottom 31 of the present invention. In an alternative embodiment, a base member 40 is provided which can be staked using spikes 42 inside a hole 22 which is dug into the ground 12 of the cemetery plot 14. This allows a removable planter 15 to be easily placed inside and removed from the base member 40. Releasable attachment means are provided which basically secure the removable planter 15 to the base member 40 by using pegs 46 which join the horizontal flanges 32 of the removable planter 15 and the base member 40.

### BACKGROUND OF THE INVENTION

1. Field of the Invention

The present invention relates generally to plant and flower pots and, more specifically, to a planter manufactured of a sturdy non-corrosive material that is placed in the ground and could be easily removed, transported and replaced without causing damage or trauma to the plant life within. The present invention could be used in cemeteries where the removal of plants or flowers is often necessary for burial or maintenance purposes and the replacement of such foliage is often desirable due to the sentimental value of such items to the friends and family of the deceased. A nameplate is provided on the front of the present invention to provide quick identification of the plot from which it is removed to insure that each planter is returned to its respective plot when more than one has been removed for maintenance purposes. The present invention is designed to comply with the rules and regulations required by most cemeteries. The removable planter for cemetery plots has tapered sides to allow for nesting one inside the other for efficient storage until issued to a plot or when not in use. The present invention could also be applied to home or commercial gardening applications wherein the rearrangement of different plants and flowers in similar containers would be quick and practical and the nameplates could be used to identify the types of plants planted therein. Furthermore, seasonal plants could be grown in a removable planter at one location and transported to another to replace a situated removable planter and the outgoing seasonals withering within thereby reducing the risk of trauma to the plants that can be caused during transplantation

A base member could also be provided which would be staked inside a hole dug in the ground and into which the removable planter could be easily removed from and replaced into thereby maintaining the integrity of the walls by preventing dirt, rocks and other debris from collapsing or falling into the hole once the removable planter is removed therefrom. A releasable attachment means could also be included for securing the removable planter to the base member until removal is desirable. An optional cover can be secured to the releasable attachment means to further protect the recess of the base member from debris during maintenance or from the elements when the removable planter is not in use due to winter storage or desuetude by the survivors of the deceased.

### DESCRIPTION OF THE PRIOR ART

There are numerous containers for plants and flowers. While these plant and flower containers may be suitable for the purposes for which they were designed, they would not be as suitable for the purposes of the present invention as heretofore described. It is thus desirable to provide a removable planter for placement in the ground at cemetery plots that can be easily removed, transported and replaced without disturbing the plant life contained therein.

### SUMMARY OF THE PRESENT INVENTION

The present invention discloses a removable planter for use in cemetery plots having tapered sides so that the planters can be nested one inside the other. A name plate is also provided to be prominently displayed on the present invention also having a horizontal flange disposed about the upper periphery of the present invention. Drain holes are also provided in the bottom of the present invention. In an alternative embodiment, a base member is provided which can be staked using spikes inside a hole which is dug into the ground of the cemetery plot. This allows a removable planter to be easily placed inside and removed from the base member. Releasable attachment means are provided which basically secure the removable planter to the base member by using pegs which join the horizontal flanges of the removable planter and the base member.

A primary object of the present invention is to provide a removable planter for cemetery plots bearing a nameplate on the front exterior wall with indicia to allow one to readily identify the designated location or contents of said removable planter when not in the ground.

Another object of the present invention is to provide a removable planter for cemetery plots manufactured of a sturdy, non-corrosive material able to withstand the elements and the acidity of the soil.

Still another object of the present invention is to provide a removable planter for cemetery plots having at least three side walls tapered from top to bottom to allow for nesting one inside the other for space efficient storage when not in use.

A further object of the present invention is to provide a removable planter for cemetery plots having a plurality of recesses in the bottom to allow for drainage when excess fluid is present.

A yet further object of the present invention is to provide a removable planter for cemetery plots having a horizontal flange extending peripherally from the side walls to help resist settling and to provide a handle when being lifted or carried.

Another object of the present invention is to provide a removable planter for cemetery plots that conforms to the rules and regulations governing the planting of flowers and plants at cemeteries.

Yet another object of the present invention is to provide a removable planter for cemetery plots having a base member slightly larger than and conforming to the basic shape of the planter wherein the base member is anchored by a stake or other means inside of a hole dug into the ground prior to the insertion of the removable planter therein to prevent the earth walls of said hole from collapsing once the removable planter is removed.

Still another object of the present invention is to provide a removable planter for cemetery plots having a securing means for releasably attaching to said base member.

Still yet another object of the present invention is to provide a removable planter for cemetery plots having a cover plate that could be releasably secured to said base member when removable planter is not in use.

Still another object of the present invention is to provide a removable planter for cemetery plots that is simple and easy to use.

One other object of the present invention is to provide a removable planter for cemetery plots that is economical in cost to manufacture.

Additional objects of the present invention will appear as the description proceeds.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become more fully appreciated as the same becomes better understood when considered in conjunction with the accompanying drawings, in which like reference characters designate the same or similar parts throughout the several views.

FIG. 1 is perspective view of the present invention installed in the ground at a cemetery plot.

FIG. 2 is a perspective view of the present invention in use removed from its place in the ground.

FIG. 3 is a perspective view of the present invention with flowers planted therein.

FIG. 4 is a perspective view of the present invention.

FIG. 5 is a top plan view of the present invention.

FIG. 6 is a front plan view of the present invention.

FIG. 7 is a right side plan view of the present invention.

FIG. 8 is a perspective view of four removable planters for cemetery plots nested inside of one another.

FIG. 9 is a front plan view of four removable planters for cemetery plots nested inside of one another.

FIG. 10 is a perspective view of the present invention in use utilizing a base member to maintain the integrity of the earthen recess.

FIG. 11 is a detail view of the base member taken from FIG. 10 as indicated.

FIG. 12 is an exploded front plan view of the present invention with a base member.

FIG. 13 is a cross-sectional front view of the present invention with base member installed in the ground.

### LIST OF REFERENCE NUMERALS

With regard to reference numerals used, the following numbering is used throughout the drawings.

| | |
|---|---|
| 10 | present invention |
| 12 | ground |
| 14 | plot |
| 15 | upper member |
| 16 | flowers |
| 18 | prior art |
| 20 | wire frame |
| 22 | hole |
| 24 | user |
| 26 | potting soil |
| 28 | front wall |
| 30 | side wall |
| 31 | bottom |
| 32 | horizontal flange |
| 34 | back wall |
| 36 | drain holes |
| 38 | name plate |
| 40 | base member |
| 42 | spikes |
| 44 | apertures |
| 46 | pegs |
| 48 | apertures |

### DETAILED DESCRIPTION OF THE PREFERRED EMBODIMENTS

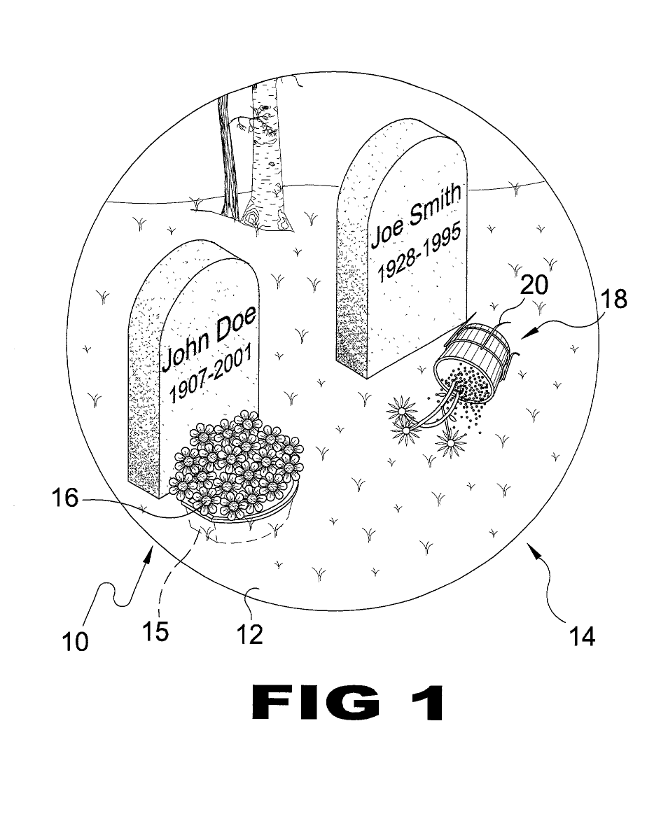

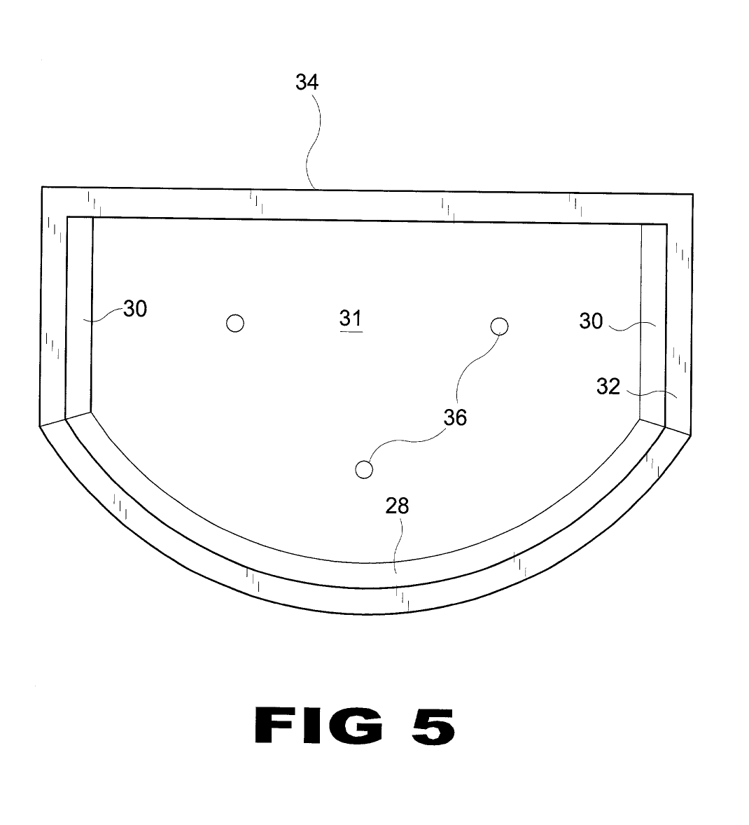

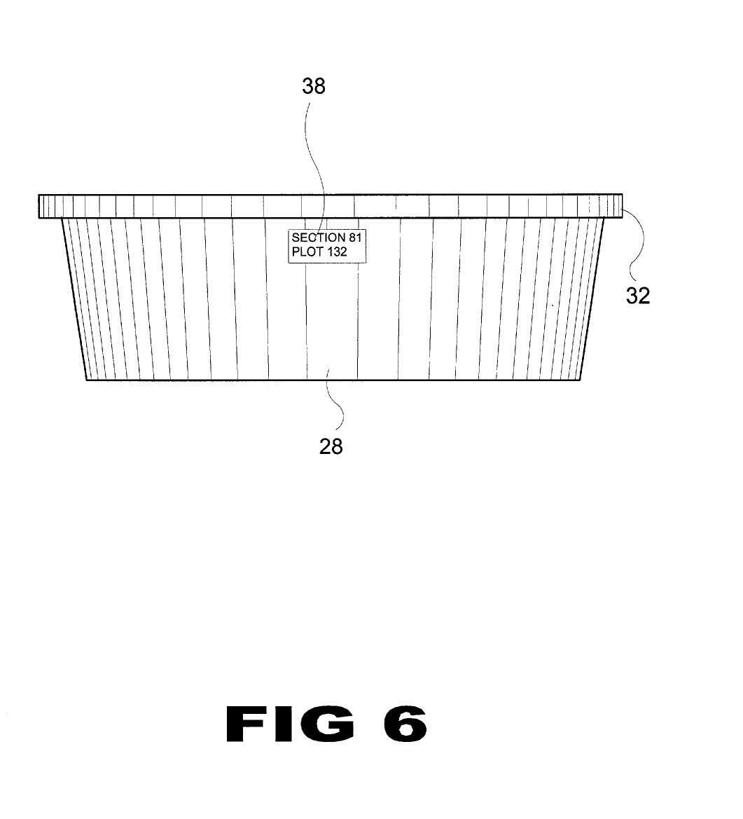

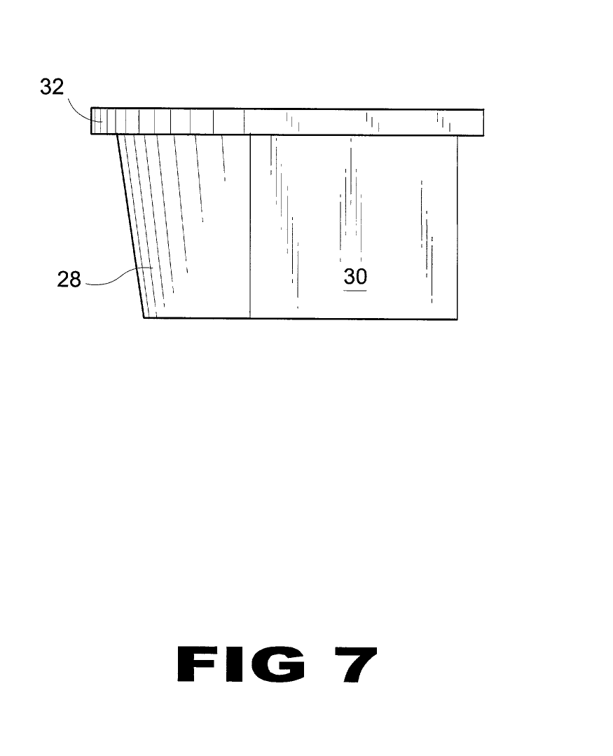

The following discussion describes in detail one embodiment of the invention and several variations of that embodiment. This discussion should not be construed, however, as limiting the invention to those particular embodiments. Practitioners skilled in the art will recognize numerous other embodiments as well. For a definition of the complete scope of the invention, the reader is directed to the appended claims. In order that the invention may be more filly understood, it will now be described, by way of example, with reference to the accompanying drawings in which FIGS. 1 through 13 illustrate the present invention being a removable planter.

Turning to FIG. 1, shown therein the present invention 10 installed in the ground 12 at a cemetery plot 14 being filled with flowers 16 with the container 15 of the planter shown in hidden line. The prior art 18 is shown in the plot beside the present invention 10 having potted flowers therein having a staked wire frame 20 overturned and damaged. It is expected that the present invention would be constructed of sturdy non-corrosive material.

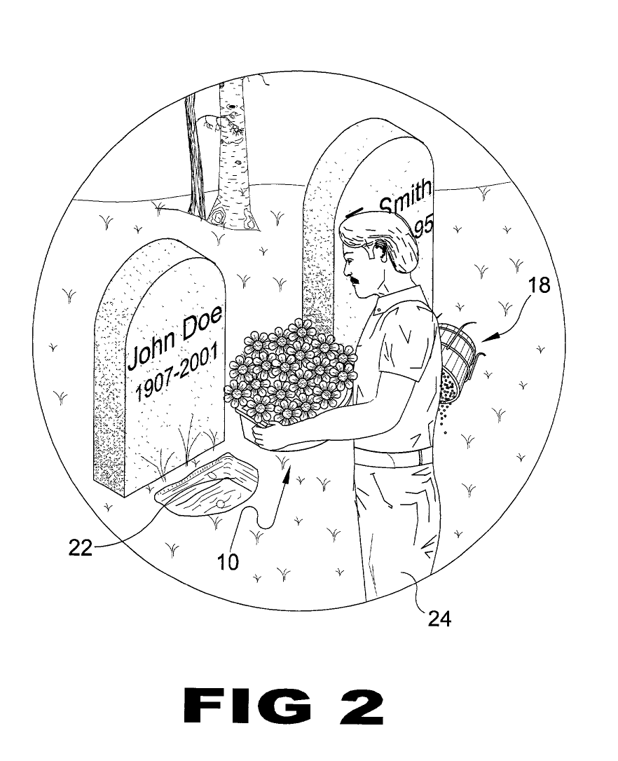

Turning to FIG. 2, shown therein is the present invention 10 being placed into a prepared hole 22 by a user 24 in such a way that it allows for the safe removal of plants. In use, the prior art 18 allows flowers or plants that are planted directly into the ground to be subject to damage or destruction during maintenance, adjacent digs, or subsequent burials at the same plot whereas the present invention 10 allows for the safe removal of plants during such activities.

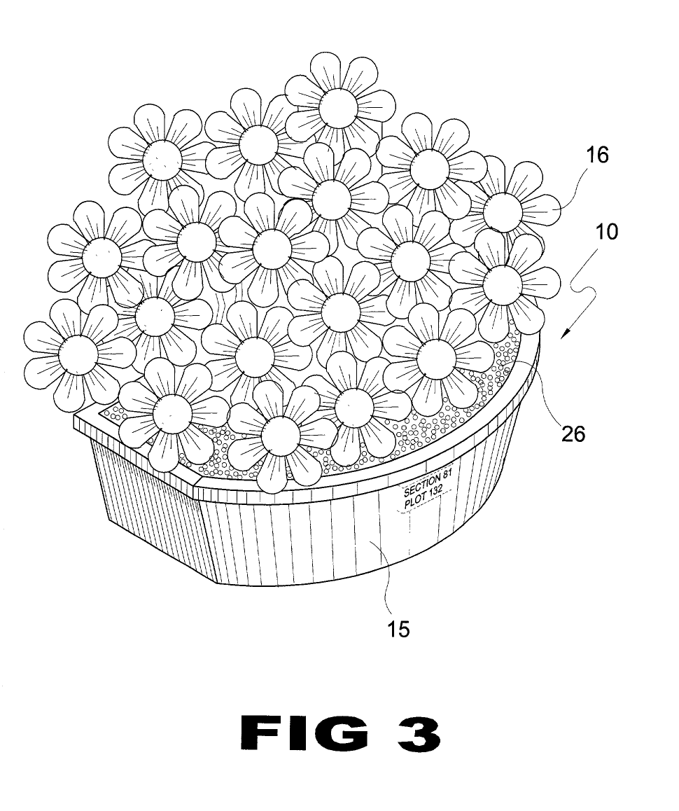

Turning to FIG. 3, shown therein is the present invention 10 having flowers 16 planted in soil 26 internal container 15.

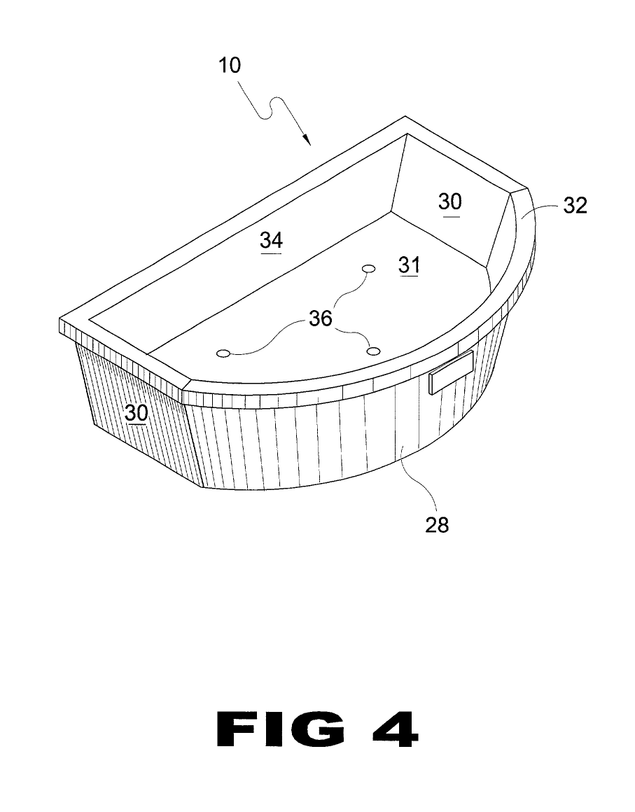

Turning to FIGS. 4 through 7, shown therein is the arcuate front wall 28 of the present invention 10 along with a pair of side walls 30 all of which are tapered from top to bottom so as to allow the present invention to be nested one inside the other for efficient storage until issued to a plot of a cemetery or when not in use. Also shown is a horizontal flange 32 which encompasses the uppermost perimeter of the present invention 10. Also shown is the back wall 34. Also shown are a plurality of apertures 36 disposed in the bottom 31 of the present invention to allow for excess drainage of fluid when it is present. Also shown is a nameplate 3 8 which is located on the front side 28 of the present invention for identifying the present invention and its corresponding cemetery plot.

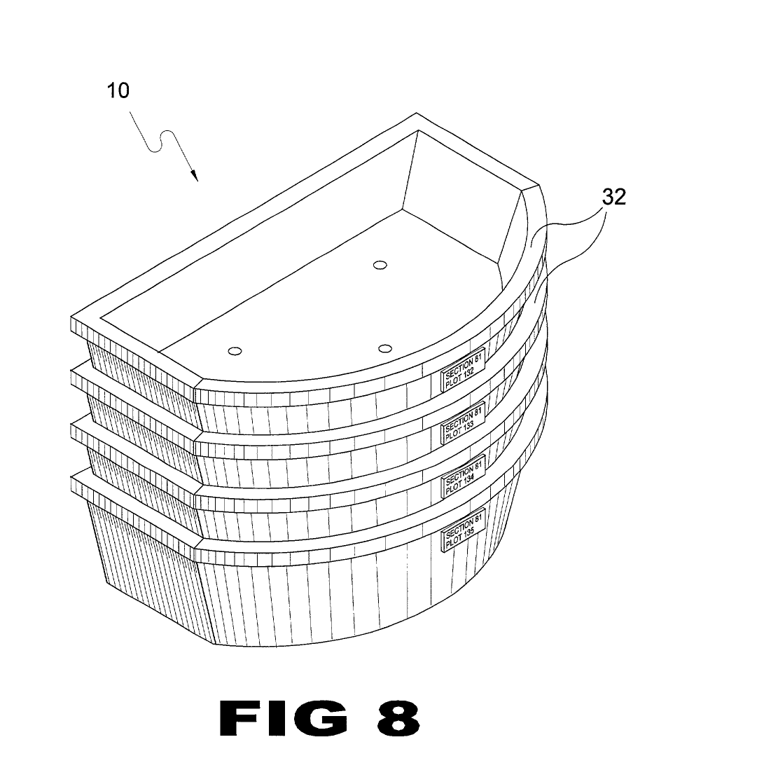

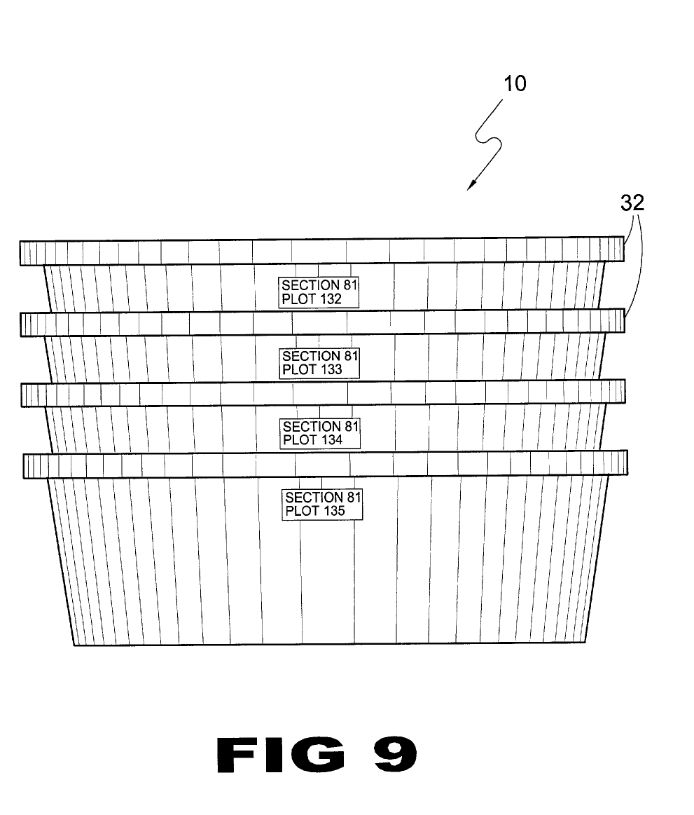

Turning to FIGS. 8 and 9, shown therein is the present invention 10 wherein a plurality of the present invention are stacked as allowed by the tapered walls which provides for stacking a plurality of the removable planters for cemetery plots or storage. Also, it can be seen that the horizontal flange would aid in preventing the present invention from settling into the ground and also act as a handle for lifting the present invention.

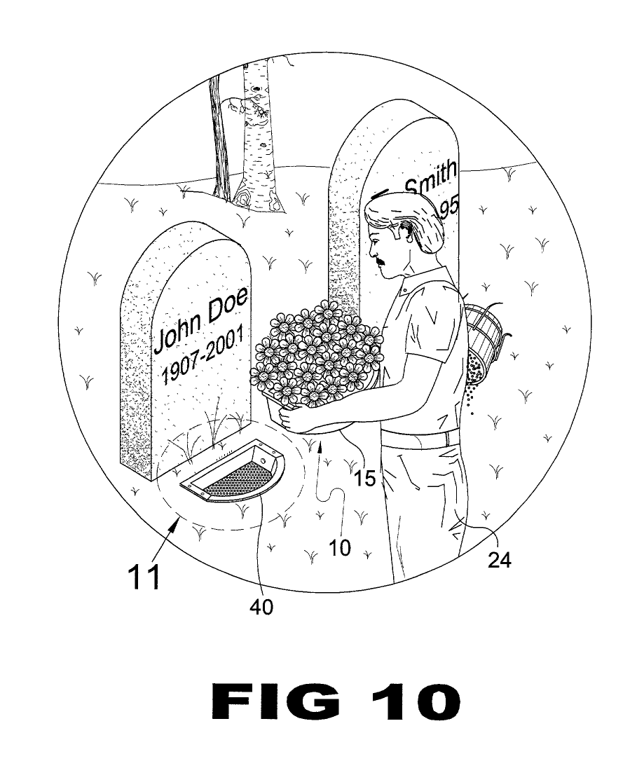

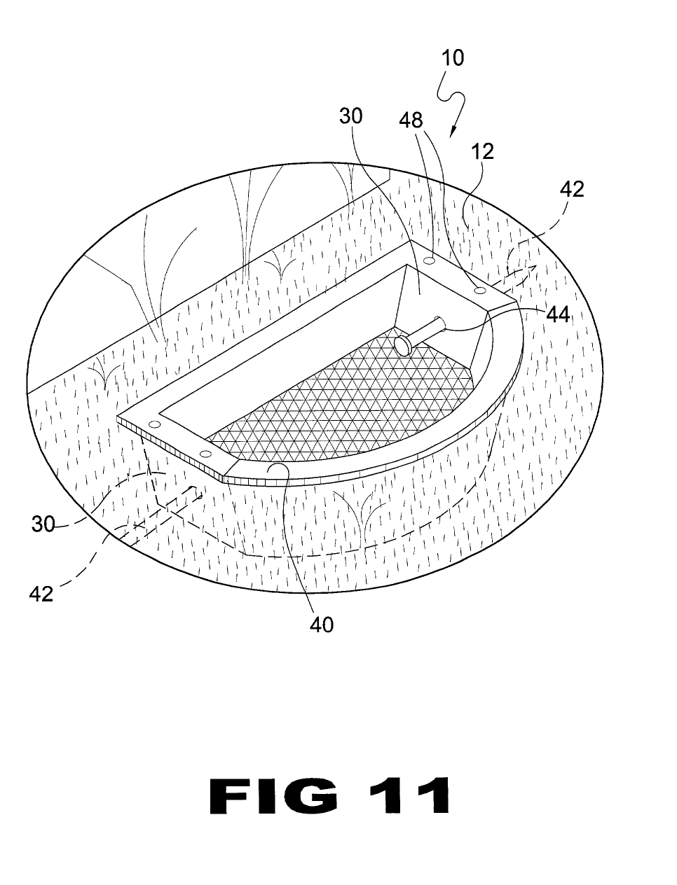

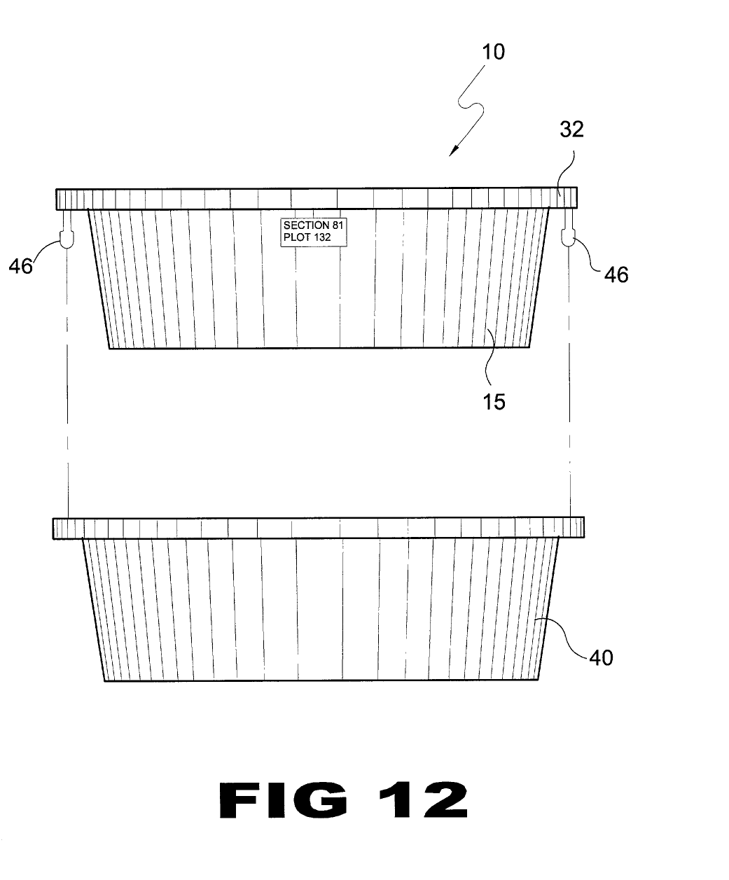

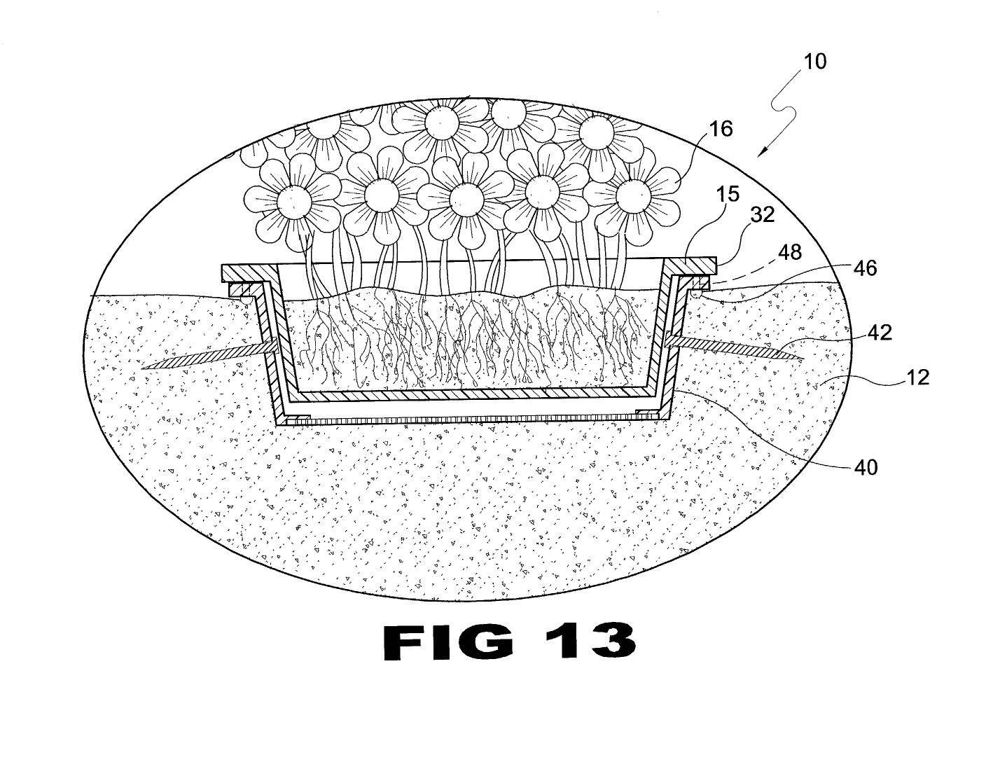

Turning to FIGS. 10 and 11, shown therein is a base container member 40 which may be used in conjunction with the upper container member 15 of the present invention 10 which will maintain the integrity of the hole dug into the ground by retaining earthen walls and preventing dirt and rocks from collapsing when the removable planter 15 is taken from the ground by a user 24. The base member 40 is anchored in place by a plurality of laterally extending spikes 42 disposed on the side walls 30 which spikes stake into the ground 12 surrounding the present invention through apertures or recesses 44 disposed in the side walls 30 of the present invention. Apertures 48 are also shown which will be further explained in conjunction with FIGS. 12 and 13. Also, an optional cover may be provided in order to prevent dirt from entering apertures 48.

Turning to FIGS. 12 and 13, shown therein are a pair of locking pegs 46 downwardly disposed on the horizontal flange of the upper member 15 of the present invention 10 which pegs allow the removable planter 15 to be releasably secured to the base member 40. The locking pegs 46 are disposed on the underside of the horizontal flange 32 whereby the pegs 46 snap into corresponding recesses 48 (not shown, but see FIG. 11) in the flange of the base member 40.

What is claimed to be new and desired to be protected by letters patent is set forth in the appended claims:

1. An apparatus for a removable planter for placement in the ground at a cemetery grave site, comprising:
a) a container, said container being open on the top, said container having a front wall, a back wall, a pair of side walls, and a bottom;
b) wherein said front wall is arcuate;
c) wherein said front wall and said pair of side walls are inwardly tapered from top to bottom;
d) a horizontal flange disposed about the upper periphery of said container; and,
e) said bottom having a plurality of apertures therein for drainage of excess fluid.

2. The apparatus of claim 1, wherein said inwardly tapered front wall and said pair of side walls are complementarily sized for stacking said containers.

3. The apparatus of claim 2, further comprising a nameplate disposed on said front wall of said container.

4. An apparatus for a removable planter for placement in the ground at a cemetery grave site, comprising:
a) a first container, said first container being open on the top, said first container having a front wall, a back wall, a pair of side walls, and a bottom;
b) wherein said front wall of said first container is arcuate;
c) wherein said front wall and said pair of side walls of said first container are inwardly tapered from top to bottom;
d) a horizontal flange disposed about the upper periphery of said first container;
e) said bottom of said first container having a plurality of apertures therein for drainage of excess fluid;
f) a second container for receiving said first container, said second container being open on the top, said second container having a front wall, a back wall, a pair of side walls, and a bottom;
g) wherein said second container is complementarily shaped as said first container;
h) a horizontal flange disposed about the upper periphery of said second container;
i) a means for removably connecting said first container to said second container; and,
j) a means for anchoring said second container into the ground of the cemetery plot.

5. The apparatus of claim 4, wherein said pair of side walls of said second container each has an aperture therein.

6. The apparatus of claim 5, wherein said horizontal flange of said second container has a plurality of apertures therein.

7. The apparatus of claim 6, wherein said means for removably connecting said first container to said second container further comprises a plurality of downwardly extending pegs disposed on the underside of said horizontal flange of said first container, said pegs for mating to said apertures in said horizontal flange of said second container.

8. The apparatus of claim 7, wherein said means for anchoring said second container into the ground further comprises a plurality of laterally extending spikes, said spikes extending through said apertures in said pair of side walls of said second container, said spikes penetrating the ground of the cemetery grave site so as to anchor said second container thereto.

9. The apparatus of claim 8, wherein said inwardly tapered front wall and said pair of side walls of said first and said second containers are complementarily sized for stacking said first and said containers.

10. The apparatus of claim 9, further comprising a nameplate disposed on said front wall of said first container.

11. The apparatus of claim 10, further comprising a cover disposed on said apertures of said horizontal flange of said second container.

12. The apparatus of claim 1, wherein said container comprises non-corrosive material.

13. The apparatus of claim 4, wherein said first and said second containers comprise non-corrosive material.
